(19) United States
(12) Patent Application Publication
(10) Pub. No.: US 2009/0212025 A1
(43) Pub. Date: Aug. 27, 2009

(54) NON-EUTECTIC STRUCTURE WELD JOINT OF COPPER-ALUMINUM THIN WALL PIPE AND ITS MANUFACTURING METHOD

(76) Inventors: Tiejun Zuo, Qingdao City (CN); Yue Zhao, Qingdao City (CN)

Correspondence Address: NIXON & VANDERHYE, PC, 901 NORTH GLEBE ROAD, 11TH FLOOR, ARLINGTON, VA, 22203, US

(21) Appl. No.: 12/382,688

(22) Filed: Mar. 20, 2009

Related U.S. Application Data
(63) Continuation of application No. PCT/CN2007/001788, filed on Jun. 6, 2007.

(30) Foreign Application Priority Data
Sep. 20, 2006 (CN) 200610153044.3

(51) Int. Cl. B23K 31/02; F16L 9/14

(52) U.S. Cl. 219/61.7; 138/155; 138/104; 138/143

(57) ABSTRACT

This invention involves a non-eutectic structure welded joint of copper-aluminum thin wall pipe and its manufacturing method. This welded joint includes a chemical bond directly formed between the cone welding section of the copper pipe and the inner wall of the aluminum pipe, to form a columnar grain crystal with a toothed profile. The method includes providing a metal rod in a nosing end of copper pipe welded part, and installing a felder at the corresponding position of fixed electrode group. During welding, a pushing cylinder pushes the travelling electrode group with copper pipe to the aluminum pipe. At the same time a circuit is connected/powered, so the copper-aluminum combined zone is heated by electric resistance heating. The copper pipe moves to the interior of aluminum pipe continuously at the role of the pushing cylinder. The cooled metal rod is drawn out after power-down. The chemical bond directly forms in copper-aluminum joint. The weld does not have eutectic structure. The weld of copper-aluminum joint has characters of high strength and good sealability, thus this joint is appropriate for large-scale use in refrigerating industry.

### FIELD OF INVENTION

This invention involves a manufacturing method which manufactures non-eutectic structure welded joint of copper-aluminum thin wall pipe, especially welded joint of plug-in copper-aluminum pipe and its manufacturing method.

This invention also involves the non-eutectic structure welded joint of copper-aluminum thin wall pipe manufactured with the method mentioned above.

### BACKGROUND OF THE INVENTION

Copper resource is in shortage relatively and aluminum resource is relatively abundant in our country. But copper pipe is widely used in refrigerating industry at present. So the subject that aluminum replaces copper for manufacturing cost reduction, has became very important. But wall thickness of major copper pipe involved in refrigerating industry is less than 1.0 mm. The special advantage of copper pipe is hardly replaced by aluminum pipe in manufacturing aspect of refrigerating pipeline, because the replacement of copper pipe by aluminum pipe entirely will bring lots of problems. The Cu—Al—Cu pipeline, i.e. both ends of copper with aluminum in the middle, could replace the only copper pipe.

Because there is a melting point difference of 400° C. between copper pipe and aluminum pipe, besides this, oxidized layer exists on inner surface of aluminum pipe, so direct chemical bond is difficult to obtain between metal atoms of two materials, and eutectic structure of copper-aluminum will not form. Eutectic structure mentioned in this instruction refers to low melting point alloy which is formed under high pressure and is composed of copper-aluminum metal compound and aluminum. There are eutectic structures in all weld seams of welded joint of plug-in copper-aluminum pipe at present. In some foreign inventions which adopt high frequency heating welding method of plug-in copper-aluminum, it could be accepted that thickness of copper-aluminum eutectic structures in weld is within 10 μm and weld seam is composed of copper-aluminum eutectic structure. But the practice proves that breaking in that weld joint of copper-aluminum pipe takes place easily in use because of copper-aluminum eutectic structure and its low peel strength. So the invention is often difficult to be put into practice.

For welding of copper-aluminum thin wall pipe, various welding methods known already at present can not prevent copper-aluminum eutectic structure from forming in weld seam entirely, neither could chemical bond of weld structure be obtained thereby. Although energy storage welding of butt joint and friction welding could reduce amount of eutectic structure by lessening end force before welding finishing, but its structure of joint determines that this process is just suitable for welding of copper-aluminum thick wall pipe of more than 1.25 mm wall thickness. So the process can not be used in welding of copper-aluminum thin wall pipe involved in this invention. Welding method of plug-in copper-aluminum pipe joint is suitable for welding of copper-aluminum thin wall pipe, but, if we adopt high frequency welding or braze welding, copper-aluminum chemical bond can not be obtained and it is too difficult to produce in large quantities because of some disadvantageous factors, such as gas cavity, copper-aluminum eutectic structure, potential corrosion danger. All these technological defects have hindered the application of aluminum pipe in refrigerating industry.

### SUMMARY OF THE INVENTION

One purpose of this invention is to provide a manufacturing method of welded joint of plug-in copper-aluminum thin wall pipe without eutectic structure in weld.

An other purpose is to provide the weld joint of copper-aluminum thin wall pipe manufactured with method mentioned above.

One example solution for a non-eutectic structure weld joint of copper-aluminum thin wall pipe in this invention includes a welded joint of copper pipe having a directed part of straight pipe and a cone welding section. An outside diameter of the directed part is slightly smaller than an inside diameter of an aluminum pipe. A chemical bond directly forms between the cone welding section of the copper pipe and the inner wall of the aluminum pipe, which becomes columnar grain crystal with a toothed profile. The weld does not have a eutectic structure. That eutectic structure is α−Al+CuAl₂.

One aspect of the invention uses the principle of cold pressure welding and electric resistance heating, to create a novel welding method. The method includes: providing one copper pipe and one aluminum pipe, respectively, providing one end of the copper pipe with a nosing; and pre-setting a metal rod in the nosing end of the copper pipe welded part. The appearance of the metal rod coincides with the inside shape of copper pipe with nosing processing. The copper pipe is put on the travelling electrode group and fixed with a high-pressure cylinder. The aluminum pipe is put on a fixed electrode group and fixed with the high-pressure cylinder. A felder is installed at the aluminum pipe's fixed position of fixed electrode group. The intracavity shape of the felder is in conformity with profile of the aluminum pipe, and the felder is composed of materials which have high heating resistance and low heat transfer efficiency. The method may include ensuring that the end of aluminum pipe is aligned with the felder edge during welding, and pushing the travelling electrode group with copper pipe to the aluminum pipe by a pushing cylinder with pressure at appropriate 150 kg˜250 kg. At the same time a circuit is powered, so the copper-aluminum combined zone is heated by electric resistance heating. The copper pipe moves to the interior of aluminum pipe continuously at the role of the pushing cylinder. During the copper pipe moving, the pushing pressure and welding current regulate the parameters (such as current, voltage, gas pressure etc.) once automatically at intervals of 1˜2 mm, so the temperature of the copper-aluminum weld can be controlled. The cooled metal rod is drawn out after power-down.

The methods mentioned above have one or more of the following characteristics. One, the metal rod (e.g., red copper), which is pre-set in the nosing end of copper pipe welded part, has three possible functions: supporting copper pipe in the course of welding, preventing copper pipe from destabilization under the high pressure, and/or absorbing heat to avoid copper-aluminum eutectic structure which forms in weld because of high temperature. In the course of copper moving to the interior of aluminum pipe, copper-aluminum eutectic structure is squeezed out of weld under the action of metal rod supporting. Two, copper and aluminum have different hardness, so utilizing high pressure which emerges when copper pipe inserts aluminum pipe, the oxide on inner surface of aluminum pipe is cleaned out. This avoids using any auxiliary additive. Three, connect the circuit and heat combined zone by electric resistance heating when the oxide is cleaned out. Pressurize while heating. This can reduce the amount of copper-aluminum eutectic structure and prevents copper pipe from distortion. Copper-aluminum eutectic structure is squeezed out by high pressure between copper and aluminum, and comprehensive performance of joint is improved. Four, remelting aluminum metal forms on outer surface of copper pipe under the synthesis action of high pressure and electric resistance heating. Welded joint of plug-in copper-aluminum pipe with big fusing area forms finally. Five, observing with the microscope enlarging 400 multiples, copper-aluminum weld seam without copper-aluminum eutectic structure forms on the aluminum side of joint. The chemical bonds in weld seam forms between copper and aluminum.

During the welding of copper-aluminum, we need control heat input at the side of aluminum pipe in order to make the temperature distribution in copper-aluminum welded zone agree with welding requirements. The scheme of this aspect of the invention is to lower electrical conductivity coefficient of electrode at the side of aluminum pipe and disperse the current density of the side of aluminum pipe, thus reducing heat input. For lowering electrical conductivity coefficient of electrode, we have studded copper electrode with the materials which have the properties of heat resistance, high temperature resistance and aluminum pipe pitting corrosion resistance.

Sample copper-aluminum eutectic structure after welding. Quarter the weld seam along the axial direction and pull aluminum pipe equally. Because weld seam with copper-aluminum eutectic structure has large brittleness, copper and aluminum can easily be separated from each other. Weld seam which possesses copper-aluminum chemical bond and has no copper-aluminum eutectic structure, could maintain original fusion state. This invention uses vernier caliper to measure weld seam without copper-aluminum eutectic structure, and the length of this weld is more than 3 mm.

In order to obtain better welding quality we could choose red copper pipe and pure aluminum pipe, although it is possible to use other types of copper and aluminum.

Near the melting temperature range of aluminum pipe, the higher the welding temperature is, the longer the high-temperature duration is, the thicker the Cu—Al eutectic structure will be. The copper pipe in which the metal rod has been put, is soaked in coolant before welding, and then welding begins. So cooling effect of the metal rod could be further enhanced, and content of copper-aluminum eutectic structure is also reduced.

Put the travelling electrode into rapid cooling liquid nitrogen and make it go through a rapid cooling process. Take it out after thoroughly cooling. This method can enhance cooling effect of the electrode and reduce content of copper-aluminum eutectic structure.

Mark the quality trailing sign on every welded joint for trailing quality easily. That is to say the felder is engraved with the concave words, so the convex words will form when the welding finishes.

### BRIEF DESCRIPTION OF THE DRAWINGS

FIG. 1 schematic diagram of welding;

FIG. 2 non-eutectic structure weld joint of copper-aluminum thin wall pipe;

FIG. 3 weld metallographic diagram of copper-aluminum weld joint with eutectic structure; and

FIG. 4 weld metallographic diagram of copper-aluminum weld joint with columnar grain crystal with tooth profile.

In the drawings, the following reference numbers are used: 1. aluminum pipe 2. the fixed electrode group 3. the felder 4. the travelling electrode group 5. the metal rod 6. copper pipe 7. the cone welding section 8. the convex words 9. directed part of straight pipe 10. copper-aluminum eutectic structure 11. columnar grain crystal with tooth profile.

### DESCRIPTION OF THE PREFERRED EMBODIMENT

With reference to FIG. 1, take one red copper pipe and one pure aluminum pipe with the same diameter respectively. One end of copper pipe (6) is processed with a nosing. The unilateral angle of nosing part is 7˜8° (taper angle 14˜16°). A metal rod (5) is pre-set in the nosing end of copper pipe welded part. Appearance of the metal rod (5), to be drawn out after welding, coincides with the inside shape of copper pipe with nosing processing. The aluminum pipe (1) maintains original state. Copper pipe (6) is put on the travelling electrode group (4) and fixed with the high-pressure cylinder. Aluminum pipe (1) is put on a fixed electrode group (2) and fixed with the high-pressure cylinder. In order to improve pitting resistance of the electrode we should make sure the weld seam parts of aluminum pipe have good mechanical strength. The felder (3) is fixed on corresponding location of the fixed electrode group (2), and the felder is composed of materials which have high heating resistance and low heat transfer efficiency, such as titanium alloy, ceramics, etc. In this example we choose titanium alloy felder and intracavity shape of felder is adapted to profile of aluminum pipe. During welding the end of aluminum pipe should be aligned with the titanium alloy felder (3), and push the travelling electrode group(4) with copper pipe to the aluminum pipe (1) by a pushing cylinder (control pressure at appropriate 150 kg˜250 kg). Copper and aluminum have different hardness, so utilizing high pressure which emerges when copper pipe (6) inserts aluminum pipe (1), the oxide on inner surface of aluminum pipe (1) is cleaned out. At the same time connect the circuit and make the cone welding section (7) be heated by electric resistance heating. Pressurize while heating. In this process copper pipe (6) moves to the interior of aluminum pipe (1) continuously. In the process of welding, displacement distance of workpiece is more than 5 mm. Copper-aluminum compound (eutectic structure) is squeezed out by high pressure and the effects of brittleness structure for the joint are avoided. The aluminum pipe melts under the synthetic action of high pressure and electric resistance heating. Under action of the titanium alloy felder (3), aluminum pipe with high-temperature state comes into being mandatory plastic deformation, so remelting aluminum metal forms on outer surface of copper pipe. There is no groove and convex deformation on copper-aluminum weld surface. Welded joint of plug-in copper-aluminum pipe with big fusing area forms finally.

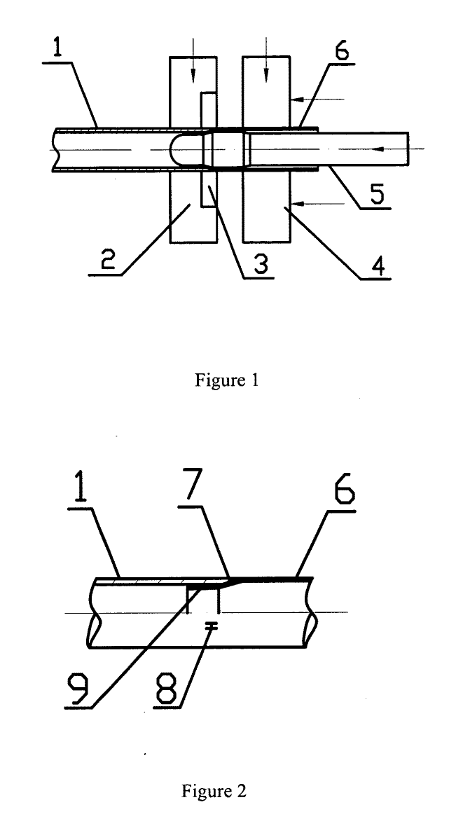

FIG. 2 shows non-eutectic structure weld joint of copper-aluminum thin wall pipe. The outside diameter of its directed part (9) is slightly smaller than the inside diameter of aluminum pipe. Copper-aluminum weld seam without copper-aluminum eutectic structure (10) forms near the cone welding section (7) of joint and its length is more than 3 mm. The chemical bonds form between copper and aluminum in this zone of weld, and columnar grain crystal with tooth profile (11) can be formed. The felder (3) is engraved with the concave words for trailing quality easily, so the convex words (8) will form on the aluminum pipe (1) surface when the welding finishes.

The above results in a welded joint of copper-aluminum pipe. Analyzing the weld cross-section by scanning electron microscope, we know columnar grain crystal with tooth profile structure(11) forms between copper pipe(6) and aluminum pipe(1). Its metallographic structure is shown in FIG. 4.

After welding we could check weld structure and composition through the method of metallographic analysis and could also use the following simple method to sample distribution zone of copper-aluminum compound (eutectic structure). Regard the outer surface of copper-aluminum weld joint as benchmark (length of aluminum pipe retained 20 mm, length of copper pipe retained 50 mm) and cut down the joint. Copper pipe is fixed by bench vise. The upside of copper pipe joins aluminum pipe. Line the end face of aluminum pipe for quartering the joint, and exscind the joint downwards with the saw up to 2 mm below weld. Hold up the exscinded copper pipe, and pull aluminum pipe slowly and equably at full tilt. Because weld with copper-aluminum eutectic structure has large brittleness, copper and aluminum can easily be separated from each other. Weld without copper-aluminum eutectic structure could maintain original state.

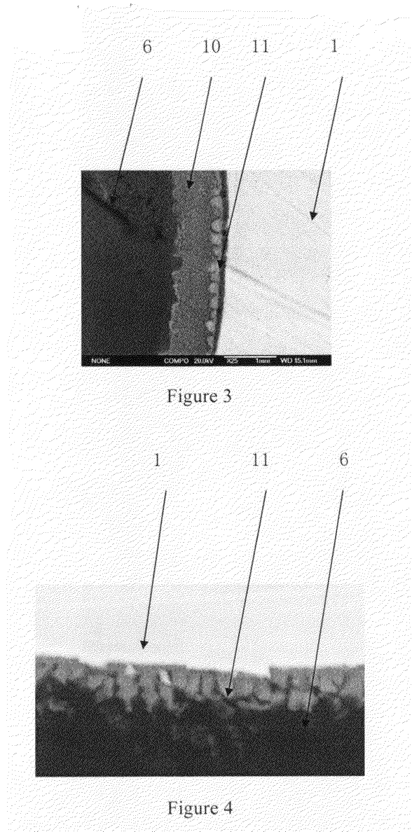

Welded joint of copper-aluminum pipe is obtained according to this invention. Because copper-aluminum eutectic structure (10), namely, lamellar α−Al+CuAl2 in FIG. 3 is reduced or eliminated, simplex columnar grain crystal with tooth profile structured 11, in FIG. 4) will form, thus the mechanical properties of materials is improved greatly. Welded joint of copper-aluminum pipe has comprehensive properties, including good performance of hot-proof and anti-vibration, longer fatigue life, higher creep resistance and intermediate temperature plasticity.

This invention explains referring to accompanying diagram and factual example, but sphere of protection is not confined in these only. The following is also in the sphere of protection: those of ordinary skill in the technical scope of this invention obtain the same technical effect alike with this invention through a simple transformation.

1. A manufacturing method which manufactures non-eutectic structure welded joint of copper-aluminum thin wall pipe, the method comprising: providing one copper pipe and one aluminum pipe, respectively, providing one end of the copper pipe with a nosing; pre-setting a metal rod in the nosing end of copper pipe welded part; placing the copper pipe on the travelling electrode group and fixing it with a high-pressure cylinder; placing the aluminum pipe on a fixed electrode group and fixing it with the high-pressure cylinder; installing a felder at the corresponding position of fixed electrode group, the felder being composed of materials which have high heating resistance and low heat transfer efficiency, and an intracavity shape of the felder is in conformity with profile of the aluminum pipe; ensuring the end of aluminum pipe is aligned with the felder during welding, pushing the travelling electrode group with copper pipe to the aluminum pipe by a pushing cylinder, at the same time connecting a circuit, so the copper-aluminum combined zone is heated by electric resistance heating moving the copper pipe to the interior of aluminum pipe continuously at the role of the pushing cylinder; during the moving, using pushing pressure and welding current, regulating the parameters once automatically at intervals of 1˜2 mm, so temperature of copper-aluminum weld can be controlled; and drawing out the metal rod after power-down and cooling.

2. A manufacturing method which manufactures non-eutectic structure welded joint of copper-aluminum thin wall pipe according to claim 1, wherein the copper pipe is red copper pipe and the aluminum pipe is pure aluminum pipe.

3. A manufacturing method which manufactures non-eutectic structure welded joint of copper-aluminum thin wall pipe according to claim 1, wherein the metal rod is red copper rod.

4. A manufacturing method which manufactures non-eutectic structure welded joint of copper-aluminum thin wall pipe according to claim 1, wherein the felder is titanium alloy felder.

5. A manufacturing method which manufactures non-eutectic structure welded joint of copper-aluminum thin wall pipe according to claim 1, further comprising soaking the copper pipe in coolant before welding, and removing the copper pipe for welding after being thoroughly cooled.

6. A manufacturing method which manufactures non-eutectic structure welded joint of copper-aluminum thin wall pipe according to claim 1, further comprising placing the travelling electrode into rapid cooling liquid nitrogen and make it go through a rapid cooling process; and removing it after thoroughly cooling and before welding begins.

7. A manufacturing method which manufactures non-eutectic structure welded joint of copper-aluminum thin wall pipe according to claim 1, further comprising engraving the felder with one or more concave words.

8. A non-eutectic structure welded joint of copper-aluminum thin wall pipe including a copper pipe and an aluminum pipe, the copper pipe having a directed part of straight pipe and a cone welding section, an outside diameter of its directed part being slightly smaller than an inside diameter of the aluminum pipe, said welded joint including a chemical bond directly formed between the cone welding section of the copper pipe and an inner wall of the aluminum pipe, thereby forming a columnar grain crystal with a toothed profile.

9. A non-eutectic structure welded joint of copper-aluminum thin wall pipe, wherein the aluminum pipe includes engravings with one or more convex words.
